(19) United States
(12) Patent Application Publication
(10) Pub. No.: US 2007/0030984 A1
(43) Pub. Date: Feb. 8, 2007

(54) Conference system

(76) Inventor: Bradley L. Gotfried, Hong Kong (HK)

Correspondence Address: AKERMAN SENTERFITT, P.O. BOX 3188, WEST PALM BEACH, FL, 33402-3188, US

(21) Appl. No.: 11/195,170

(22) Filed: Aug. 2, 2005

(51) Int. Cl. H04R 3/00

(52) U.S. Cl. 381/122

(57) ABSTRACT

A system for conducting a meeting which includes at least one control system, and a plurality of microphones configured to transmit an activation request to the control system. The control system generates an activation sequence for the microphones based on at least one activation request transmitted by a user for at least one of the microphones. The control system selectively activates each microphone for which an activation request has been transmitted. The selective activation occurs according to the generated activation sequence. One or more cameras may also be included for capturing video images of the users speaking into the microphones.

### BACKGROUND OF THE INVENTION

1. Technical Field

The present invention relates to a system for conducting a meeting, and more particularly providing an orderly news conference or meeting.

2. Description of Related Art

Audio and video systems are used in a wide variety of situations. Generally, audio and video systems with recording functions are used to capture the sounds and images of a particular event. One example of a particular event where audio and video systems are used to record the event is a news conference.

Generally, conducting a news conference requires expensive and bulky multimedia equipment such as a great number of cameras, camera stands, microphones, recording equipment, and display equipment. A support staff is typically needed to operate the multimedia equipment. In addition to the support staff, news conferences typically include a plurality of reporters from television stations, newspaper magazines, and radio stations. Combining all of these people and multimedia equipment into the same room where the news conference is conducted can lead to a disorderly event.

News conferences where a plurality of individuals will be speaking tend to produce an even more disorderly event. Some news conferences do not establish a particular order for time periods when certain individuals can express their views or questions. This lack of order can lead to more than one individual speaking at a time and can prevent others from hearing and recording what each individual says. Additionally, camera operators may find it difficult to determine exactly at whom they should focus their cameras. Such a disorderly system can lead to a less productive news conference.

Various audio and video systems have been developed for capturing voice and image data from a plurality of speakers. For example, U.S. Pat. No. 5,426,510 to Meredith is directed to an audio/video system that includes several cameras and microphones for use in a courtroom or other adversarial setting, and which can record the various events occurring within the room. The system includes several cameras, microphones and video cassette recorders under the control of a Judge or other Official of the court. The cameras are activated to record upon receiving an audio signal from one of the microphones. A sound system provides the audio to the courtroom and remote video monitors may also be provided outside the courtroom. A programmable logic assembly insures that the camera switching is operated according to predefined camera switching rules. An audio mixer and an automatic gain controller are provided to improve the overall audio quality associated with the output signals of the microphones. Additionally, the system includes encoder and decoder means for ascertaining faults with the audio and video system. The system is reactive to audio signals from the microphones, meaning that several participants may attempt to speak at once.

In another example, U.S. Pat. No. 5,959,667 to Maeng is directed to a video conferencing system having a voice activated camera preset selection system. The system includes a microphone array that receives the voices of speakers. The microphone array is coupled to a conference control unit that includes a locator that is operable to receive the audio signals from the microphone array and to provide position data representing the location of the microphone. The locator is coupled to the voice activated camera preset selection system so that the camera can respond to the preset data and view the speaker that is at the microphone receiving the audio signals. The camera preset is defined in several embodiments whereby triangulation or the like can determine the location of a speaker.

Notably, the above-noted and other known systems do not have a control function whereby activation of the microphones can be controlled.

### SUMMARY OF THE INVENTION

The present invention concerns a system for conducting a meeting. The system includes at least one control system, and a plurality of microphones configured to transmit an activation request to the control system. The control system generates an activation sequence for the plurality of microphones based on at least one activation request transmitted by a user for at least one of the microphones. The control system then selectively activates each microphone for which an activation request has been transmitted, with the selective activation occurring according to the generated activation sequence. This arrangement enables a meeting to be run smoothly and efficiently, with the minimum amount of expensive equipment. In addition, the meeting participants are queued so that they can ask questions of a speaker or other meeting participants in an orderly manner.

In one arrangement, the activation request can be initiated by a user-operable activation request button associated with each microphone.

In one arrangement, the activation request includes an identification signal identifying the microphone from which it was transmitted. At least one input device may be included, whereby user identifying indicia can be inputted. The user identifying indicia may be associated with a microphone used by a particular user, and may be transmitted to the control system with the microphone identification signal. At least one display device may also be included. The display device can display the user identifying indicia of the user speaking on an activated microphone.

At least one display device may be included for displaying the activation sequence of the microphones.

The control system may generate the activation sequence in a processor. The control system may include a memory for storing the activation sequence.

In one arrangement, the activation request is transmitted wirelessly from each microphone to the control system. The wireless transmission of the activation request may be at a radio frequency.

In a preferred arrangement, each microphone may include a notification device for notifying a user when the microphone is activated by the control system. The notification device may include at least one of a display device, an illumination source and a structure for generating a vibration.

The microphones may be portable. Each microphone may be powered by batteries, which may be rechargeable. At least one recharging station may be included for recharging the batteries of at least one of the plurality of microphones. At least one camera may be incorporated in the system. The control system can direct the camera substantially towards an activated microphone for at least one of recording and transmitting a video image of a user speaking into the activated microphone. The control system may be configured to record and/or transmit at least one of audio and video signals. The transmission may be to a remote location. At least one sensor for sensing the location of an activated microphone may be included. The camera may be directed to the sensed location of the activated microphone.

In one arrangement, at least two cameras may be provided. The control system may direct a second camera substantially towards the next microphone to be activated in the activation sequence for recording a video image of the next user that has requested to speak into an activated microphone. A switching system may be included to switch at least one of recording and transmitting a video image from a first camera to the second camera upon activation of the next microphone to be activated..

The control system may include at least one input device so that override instructions may be entered to override the activation sequence.

The control system may be configured to perform at least one diagnostic test to determine if said system is functioning properly. A display device may display the results of the diagnostic tests.

The control system may activate each activated microphone for a predetermined time period and may deactivate the microphone upon expiration of the predetermined time period. Alternatively or in addition, each microphone may include a user operable off switch for deactivating the microphone, with the user operable off switch only functioning after the microphone has been activated by the control system.

The control system may generate an alert notification to the next microphone to be activated in the activation sequence. The microphone may include a notification device for notifying a user when the microphone is next to be activated by the control system. The notification device may include at least one of a display device, an illumination source and structure for generating a vibration.

In another arrangement of the invention, each microphone may be associated with a display device, each display device displaying at least one of the turn number of the microphone in the activation sequence and the approximate time remaining to activation of the microphone once an activation request from the microphone has been received and processed by the control system. Each display device may be configured to display a “no activation request” message if no activation request has been made for that microphone.

The control system may include a setting to deny activation requests after at least one of a predetermined time period and an instruction from a person controlling the meeting. The system may include a user operable activation request cancellation button for canceling the activation request for a particular microphone.

### BRIEF DESCRIPTION OF THE DRAWINGS

FIG. 1 illustrates one embodiment of a microphone in accordance with the invention.

FIG. 2 is a schematic diagram illustrating components of the microphone of FIG. 1.

FIG. 3 illustrates an arrangement of a system in accordance with the invention, and incorporating a plurality of microphones of FIG. 1.

FIG. 4 illustrates an embodiment of a combined microphone and camera terminal in accordance with the invention.

FIG. 5 illustrates another arrangement of a system in accordance with the invention.

### DETAILED DESCRIPTION OF THE PREFERRED EMBODIMENTS

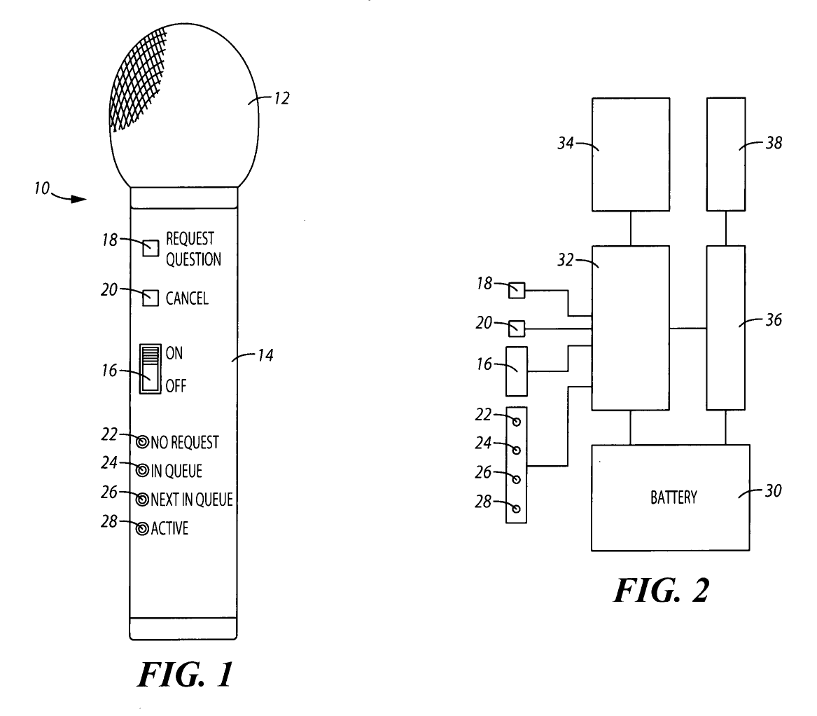

Referring to the drawings, the present invention relates to a system for conducting a meeting. One embodiment of a microphone 10 for use in a system is illustrated in FIG. 1. The microphone 10 includes an audio receiver head 12 and a handle 14. The handle 14 may include several user operable control switches, such as an on/off switch 16, a “Request Question” button 18 and a “Cancel” button 20. The handle may further include LED indicator lights, which may include a “No Request” light 22, an “In Queue” light 24, a “Next In Queue” light 26, and an “Active” light 28. It will be appreciated that the illustrated user operable switches, buttons and the indicator lights are exemplary only, and that any suitable operative elements including activation request buttons or switches, and indicators may be used.

As shown in FIG. 2, the microphone 10 may include a portable power supply such as a battery 30, which may be rechargeable. The battery 30 may be connected to a processor 32 which can receive input from the user operable switches 16, 18 and 20, and which can operate the indicator lights 22, 24, 26 and 28. The processor 32 may also be connected to an audio receiver 34, which is typically placed in the head of the microphone 10 to receive sound generated by the user. The processor 32 may also be connected to an RF transmitter and receiver 36, which may in turn be connected to an antenna 38. Any suitable components may be used to form the microphone 10, and the invention is not limited to those shown and described.

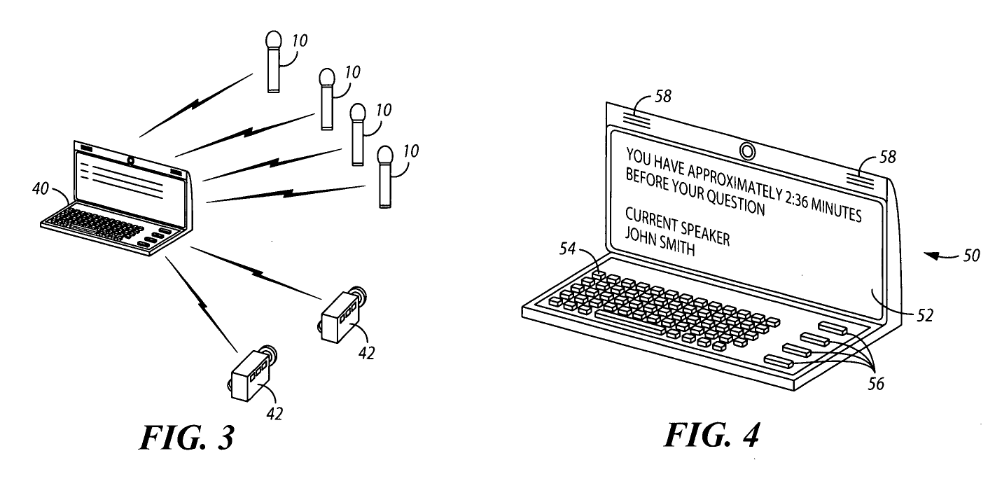

A meeting system according to an arrangement of the invention is illustrated in FIG. 3. In the meeting system a plurality of microphones 10 are provided in wireless or wired communication with a central control system 40. One or more cameras 42 may also be provided, which may be controlled by the control system 40, or may be manually controlled. The control system 40 may include an input for the main speaker to indicate when an answer to a question has been given, and when it is time for the control system to activate the next microphone in the queue for receipt of the next question.

In a news conference or other meeting setting, the audience participants may be given portable microphones as they enter the meeting. In order to use the microphone 10, a user may first switch the microphone 10 on using the on/off switch 16. This may cause the “No Request” indicator light 22 to light up, indicating to the user that they have not yet requested to ask a question of the meeting, and also that the microphone 10 is on. If the user wishes to ask a question of the meeting chair or person giving the news conference, they can depress the “Request Question” button 18. The depression of the “Request Question” button 18 is sensed by the processor 32, which generates an activation request. The activation request is a signal that is transmitted by the RF transmitter/receiver 36 via the antenna 38 to the central control system 40. The processor 32 may also cause the “No Request” light 22 to be switched off, and the “In Queue” light 24 to be lit once the activation request has been sent to the central control system. The activation request is received by the central control system 40, which may return a signal to the microphone 10 indicating that the activation request has been placed in the queue. In one arrangement, the “In Queue” light 24 may only be activated by the processor 32 once a return signal has been received from the central control system 40.

The activation request signal sent to the central control system 40 by the processor 32 may include an identification signal identifying the microphone 10. The central control system 40 decides the order in which to activate each microphone 10 to allow the participants to ask questions. The timing of the question may be triggered by the main speaker or person giving the news conference indicating that they have finished answering the previous question, or each user may be given a predetermined time period for their question and answer. The control system 40 returns an activation signal to the microphone 10 in order to activate the microphone 10. The microphone 10 then signals to the user holding it that it is about to become active, by lighting the “Active” indicator light 28, and/or by vibrating the microphone 10, or by emitting a sound, or by any other means. In one arrangement, the control system 40 may signal the microphone 10 that it is next to be activated. On receipt of the “next to be activated” signal, the microphone 10 can light the “Next In Queue” indicator light 26, and/or can indicate to the user by vibrating, emitting a sound or any other means. This alerts the user to be ready to ask their question.

After activation of the microphone 10 by the control system 40, the user speaks into the microphone 10, with the audio receiver 34 picking up the user's voice. The sound is processed by the processor 32 and relayed via the RF transmitter/receiver 36 and the antenna 38 to one or more loudspeakers, and/or to a recording device (not shown). When the user has completed their question, they can either operate the on/off switch 16 or the cancel button 20. This signals to the microphone 10 that it is to stop transmitting the user's voice. In addition the processor 32 can send an “end of question” signal to the control system 40 so that the control system can alert the next microphone in the queue. The cancel button 20 may also be used if the user decides that they no longer wish to ask a question of the meeting, for example if another user has already asked a similar question. If the cancel button 20 is pressed before the microphone 10 is activated, the microphone 10 can transmit a “cancel” signal to the control system 40 to remove the microphone 10 from the queue.

In a news conference setting, one or more cameras 42 may be located in the news conference room. One camera 42 may be permanently directed towards the main speaker, and one or more other cameras 42 may be used to capture video images of each person asking a question at the news conference. The cameras 42 may be driven manually, or the system may include one or more sensors (not shown) to automatically determine the position of the active microphone 10, and to direct the camera toward the microphone 10. The sensors may work using RF, such as by a triangulation method. Alternatively, the cameras 42 may simply be static, and may record video images of the entire audience or a section of the audience at one time.

The cameras 42 may include two or more cameras such that, while one camera is recording video images of the active microphone 10 and its user, a second camera may receive a signal indicating the location of the next microphone 10 in the queue to be activated. This enables the camera to be focused on the next user to ask a question in advance of the activation of their microphone 10. The focusing may either be done manually or automatically. The control system 40 may include a switching system to switch a displayed video image on activation of the second microphone 10.

The meeting system may include a diagnostic test system. This may be provided as a program loaded on the central control system 40. The diagnosis system can detect technical problems in the system, and can display a warning advisory on a display screen.

An alternative arrangement of microphone system is illustrated in FIG. 4. The microphone system of FIG. 4 is in the form of a terminal 50, which incorporates a display screen 52, data input means 54, user operable buttons 56, audio receivers 58 and a built-in camera 60. The arrangement of FIG. 4 may be suitable for meeting settings where desks or other permanent speaking locations are used, such as large lecture theaters, committee meeting rooms and other settings.

The data input means 54 allows the user seated at the terminal to input their identity. The data input means 54 may be a keyboard, or may be another device such as an identification card reader, a thumbprint device or any other identification device. When the user seats themselves at the terminal 50, they can either type in their identity, or can, for example, scan an identification card into a reader. The terminal 50 may be interrogated by a control system to ensure that the person identified as seated at the terminal is authorized to participate in the meeting. If the person is not authorized to participate in the meeting, access to questions may be denied by the control system. An identification check may be useful in a parliamentary, courtroom or committee-type setting where only certain persons may be authorized to speak. Once the user's identity has been input in the terminal 50, and optionally once their identity has been checked, the user's name and any other identifying indicia, such as company name, region represented, title, etc, can be transmitted to the control system along with the microphone identity. The user's identity can then be displayed while they are speaking. The camera 60 may also record a video image of the user for display. The identity of the user and their image may be displayed on a central display screen, or on the display screens 52 of all the terminals 50 that are participating in the meeting. The display 52 can also display the time remaining until the microphone 50 is activated, to alert the user as to when their speaking turn will be.

A built-in camera 60 may be particularly useful where it is not desirable to provide separate video cameras, or where one or more of the participants are located remotely from the main speaker or other meeting participants. The camera 60 can capture the video image of the user, which can be transmitted together with the audio signal via a LAN, via the internet or any other remote connection.

The user operable switches 56 may include a request question button, a cancel button, and on and off buttons in a similar manner to the microphone 10 of FIG. 1. The buttons 56 can be operated by the user to cause the terminal 50 to transmit activation requests and other signals to a central control system.

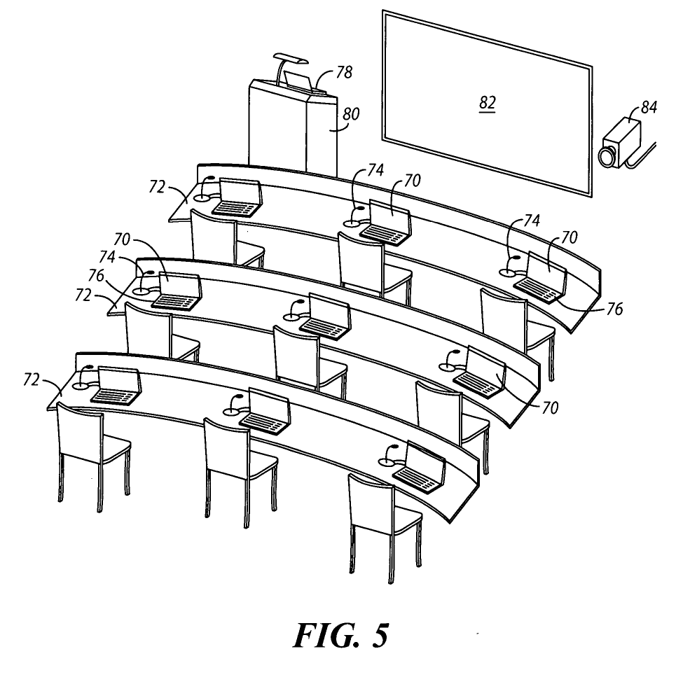

FIG. 5 illustrates a further arrangement of the invention. A terminal 70, similar to that illustrated in FIG. 4, is provided at desks 72. A microphone 74 is also provided, adjacent each terminal 70. The terminal 70 includes data input means 76, such as a keyboard, at which a user can enter their identity. A central control system 78 is provided, such as at a lectern 80, at which a lecturer or other main speaker may control the meeting. A central display screen 82 and a central camera 84 may be provided. The terminal 70 is used for requesting activation and operating the other features of the microphone 74. The control system 78 can display to the lecturer the name and location of the person that wishes to ask the next question. The lecturer can input into the control system 78 that the next question is allowed, and the terminal 70 of the user that requested the next question can indicate to the user that their microphone 74 is activated. The camera 84 may be automatically controlled to point to the microphone 74 that is activated, in order to display a video image of the participant on the central display screen 82. The video image may contain the user's identification.

One or more of the terminals 70 may be incorporated into computers connected to a network such as the internet. Any remote terminals 70 may be provided with their own microphones 74 and cameras 84, which can be simple built-in devices commonly provided with personal computers. This system enables, for example, college lectures to be delivered remotely to some students via the internet or any other network while other students are present on-campus. This can allow all students an equal opportunity to question the lecturer, and the control system 78 will inform the lecturer which student is next in the queue. The lecturer may manually allow questions from the students, as a request is queued up, or a predetermined time for questions at the end of the lecture may be programmed in to the system. The camera on the remote student's computer may transmit both the audio and a video image of the student to the central control system 78 for display on the central display screen 82. The control system 78 may also transmit all images displayed on the central display screen 82, and audio captured by the microphones 74 to the remote students' computers.

Although the present invention has been described in conjunction with the embodiments disclosed herein, it should be understood that the foregoing description is intended to illustrate and not limit the scope of the invention as defined by the claims.

What is claimed is:

1. A system for conducting a meeting, comprising:
at least one control system; and
a plurality of microphones configured to transmit an activation request to said control system;
wherein said control system generates an activation sequence for said plurality of microphones based on at least one activation request transmitted by a user for at least one of said microphones, and
wherein said control system selectively activates each microphone for which an activation request has been transmitted, said selective activation occurring according to said generated activation sequence.

2. The system of claim 1, wherein said activation request is initiated by a user-operable activation request button associated with each microphone.

3. The system of claim 1, wherein said activation request includes an identification signal identifying the microphone from which it was transmitted.

4. The system of claim 3, further comprising at least one input device whereby user identifying indicia can be inputted, the user identifying indicia being associated with a microphone used by a particular user, and the user identifying indicia being transmitted to the control system with the microphone identification signal.

5. The system of claim 4, further comprising at least one display device, the display device displaying the user identifying indicia of the user speaking on an activated microphone.

6. The system of claim 1, further comprising at least one display device, the display device displaying the activation sequence of the microphones.

7. The system of claim 1, wherein said control system generates the activation sequence in a processor.

8. The system of claim 1, wherein said control system includes a memory for storing the activation sequence.

9. The system of claim 1, wherein the activation request is transmitted wirelessly from each microphone to said control system.

10. The system of claim 9, wherein the wireless transmission of the activation request is at a radio frequency.

11. The system of claim 1, wherein each microphone includes a notification device for notifying a user when the microphone is activated by the control system.

12. The system of claim 11, wherein said notification device includes at least one of a display device, an illumination source and a structure for generating a vibration.

13. The system of claim 1, wherein said microphones are portable.

14. The system of claim 13, wherein each microphone is powered by batteries.

15. The system of claim 14, wherein the batteries are rechargeable.

16. The system of claim 15, further comprising at least one recharging station for recharging the batteries of at least one of said plurality of microphones.

17. The system of claim 1, further comprising at least one camera, wherein said control system directs said at least one camera substantially towards an activated microphone for at least one of recording and transmitting a video image of a user speaking into the activated microphone.

18. The system of claim 17, wherein said control system is configured to record at least one of audio and video signals.

19. The system of claim 17, wherein said control apparatus is configured to transmit at least one of audio and video signals to a remote location.

20. The system of claim 17, further comprising at least one sensor for sensing the location of an activated microphone.

21. The system of claim 20, wherein said at least one camera is directed to the sensed location of the activated microphone.

22. The system of claim 17, wherein at least two cameras are provided, the control system directing a second camera substantially towards the next microphone to be activated in said activation sequence for recording a video image of the next user that has requested to speak into an activated microphone.

23. The system of claim 22, further comprising a switching system to switch at least one of recording and transmitting a video image from a first camera to the second camera upon activation of the next microphone to be activated.

24. The system of claim 1, wherein said control system includes at least one input device whereby override instructions may be entered to override the activation sequence.

25. The system of claim 1, wherein said control system is configured to perform at least one diagnostic test to determine if said system is functioning properly.

26. The system of claim 25, wherein a display device displays results of said diagnostic tests.

27. The system of claim 1, wherein said control system activates each activated microphone for a predetermined time period and deactivates said microphone upon expiration of said predetermined time period.

28. The system of claim 1, wherein each microphone includes a user operable off switch for deactivating the microphone, wherein the user operable off switch is only functional after the microphone has been activated by the control system.

29. The system of claim 1, wherein the control system generates an alert notification to the next microphone to be activated in the activation sequence.

30. The system of claim 29, wherein the microphone includes a notification device for notifying a user when the microphone is next to be activated by the control system.

31. The system of claim 30, wherein said notification device includes at least one of a display device, an illumination source and structure for generating a vibration.

32. The system of claim 1, wherein each microphone is associated with a display device, each display device displaying at least one of the turn number of the microphone in the activation sequence and the approximate time remaining to activation of the microphone once an activation request from the microphone has been received and processed by the control system.

33. The system of claim 1, wherein each microphone is associated with a display device, each display device being configured to display a “no activation request” message if no activation request has been made for that microphone.

34. The system of claim 1, wherein said control system includes a setting to deny activation requests after at least one of a predetermined time period and an instruction from a person controlling the meeting.

35. The system of claim 1, further comprising a user operable activation request cancellation button for canceling the activation request for a particular microphone.
